(19) United States
(12) Patent Application Publication
(10) Pub. No.: US 2019/0205385 A1
(43) Pub. Date: Jul. 4, 2019

(54) METHOD OF AND SYSTEM FOR GENERATING ANNOTATION VECTORS FOR DOCUMENT

(71) Applicant: YANDEX EUROPE AG, Luzern (CH)

(72) Inventors: Aleksey Yurievich GUSAKOV, Moscow (RU); Andrey Dmitrievich DROZDOVSKY, Moscow (RU); Valery Ivanovich DUZHIK, Minsk (BY); Pavel Vladimirovich KALININ, Belgorodskaya obl. (RU); Oleg Pavlovich NAYDIN, Moscow (RU); Aleksandr Valerievich SAFRONOV, Moskovskaya obl. (RU)

(21) Appl. No.: 16/190,441

(22) Filed: Nov. 14, 2018

(30) Foreign Application Priority Data
Dec. 29, 2017 (RU) 2017146890

(51) Int. Cl. G06F 17/27; G06F 17/30; G06N 3/08

(52) U.S. Cl. CPC G06F 17/2785; G06F 17/30011; G06N 3/04; G06N 3/08; G06F 17/274; G06F 17/30864

(57) ABSTRACT

A method and a system for generating a plurality of annotation vectors for a document, the plurality of annotation vectors to be used as features by a first machine-learning algorithm (MLA) for information retrieval, the method executable by a second MLA on a server, the method comprising: retrieving the document, the document having been indexed by a search engine server, retrieving a plurality of queries having been used to discover the document, retrieving a plurality of user interaction parameters for each one of the plurality of queries, generating the plurality of annotation vectors, each annotation vector being associated with a respective query of the plurality of queries, each annotation vector of the plurality of annotation vectors including an indication of: the respective query, a plurality of query features, the plurality of query features being at least indicative of linguistic features, and the plurality of user interaction parameters.

### CROSS-REFERENCE

The present application claims priority to Russian Patent Application No. 2017146890, entitled “Method of and System for Generating Annotation Vectors for Document”, filed Dec. 29, 2017, the entirety of which is incorporated herein by reference.

### FIELD

The present technology relates to machine learning algorithms in general and, more specifically, to a method of and a system for generating annotation vectors for a document.

### BACKGROUND

Machine learning algorithms (MLAs) are used to address multiple needs in computer-implemented technologies. Typically, the MLAs are used for generating a prediction associated with a user interaction with a computer device. One example of an area where such prediction is required is user interaction with the content available on the Internet (as an example).

The volume of available information through various Internet resources has grown exponentially in the past couple of years. Several solutions have been developed in order to allow a typical user to find the information that the user is looking for. One example of such a solution is a search engine. Examples of the search engines include GOOGLE™ search engine, YANDEX™ search engine, YAHOO!™ search engine and the like. The user can access the search engine interface and submit a search query associated with the information that the user is desirous of locating on the Internet. In response to the search query, the search engine provides a ranked list of search results. The ranked list of search results is generated based on various ranking algorithms employed by the particular search engine that is being used by the user performing the search. The overall goal of such ranking algorithms is to present the most relevant search results at the top of the ranked list, while less relevant search results would be positioned on less prominent positions of the ranked list of search results (with the least relevant search results being located towards the bottom of the ranked list of search results).

The search engines typically provide a good search tool for a search query that the user knows apriori that she/he wants to search. In other words, if the user is interested in obtaining information about the most popular destinations in Italy (i.e. a known search topic), the user could submit a search query: “The most popular destinations in Italy?” The search engine will then present a ranked list of Internet resources that are potentially relevant to the search query. The user can then browse the ranked list of search results in order to obtain information she/he is interested in as it related to places to visit in Italy. If the user, for whatever reason, is not satisfied with the uncovered search results, the user can re-run the search, for example, with a more focused search query, such as “The most popular destinations in Italy in the summer?”, “The most popular destinations in the South of Italy?”, “The most popular destinations for a romantic getaway in Italy?”.

In the search engine example, the MLA is used for generating the ranked search results. When the user submits a search query, the search engine generates a list of relevant web resources (based on an analysis of crawled web resources, an indication of which is stored in a crawler database in a form of posting lists or the like). The search engine then executes the MLA to rank the so-generated list of search results. The MLA ranks the list of search results based on their relevancy to the search query. Such the MLA is “trained” to predict relevancy of the given search result to the search query based on a plethora of “features” associated with the given search result, as well as indications of past users' interactions with search results when submitting similar search queries in the past.

Neural networks (NN) and deep learning based MLAs have been proven to be useful MLAs for ranking web resources in response to queries. Briefly speaking, neural networks are typically organized in layers, which are made of a number of interconnected nodes that contain activation functions. Patterns may be presented to the network via an input layer connected to hidden layers, and processing may be done via the weighted connections of nodes. The answer is then output by an output layer connected to the hidden layers.

Pluralities of techniques have been developed to improve the different MLAs including the neural networks that are used for ranking web resources.

U.S. Pat. No. 7,895,235 titled “Extracting semantic relations from query logs” and granted on Feb. 22, 2011 to Yahoo! Inc. teaches methods, systems, and apparatuses for associating queries of a query log. The query log lists a plurality of queries and a set of clicked URLs for each query. Each query is designated to be a node of a plurality of nodes. A plurality of edges is determined. A URL is designated to be an edge for a pair of queries if the URL is indicated as clicked in the sets of clicked URLs for both queries of the pair. The nodes and edges are displayed in a graph. Each edge may be displayed in the graph as a line connected between a pair of nodes that correspond to the pair of queries of the pair of nodes. The edges may be classified. Furthermore, the edges and/or the nodes may be weighted. Edges and/or nodes may be filtered from display based on their weights and/or on other criteria.

U.S. Pat. No. 8,543,668 titled “Click tracking using link styles” granted on Sep. 24, 2013 to Google Inc. teaches methods, systems, and apparatus for tracking user clicks on result links in a search result webpage. In one aspect, a method includes generating one or more webpages each including a link to a destination document; specifying a style for the link in each webpage according to a style sheet language, the style including a behavior trigger indicating user selection of the link and a display property that causes retrieval of a resource from a remote server when the behavior trigger is activated; providing the webpages with the specified style to a plurality of clients; receiving at the remote server one or more requests from at least one of the plurality of clients for the resource; and in response to the receiving, recording a count for user selection of the destination document based on a number of received requests for the resource.

U.S. Pat. No. 9,507,861 titled “Enhanced query rewriting through click log analysis” and granted on Nov. 29, 2016 to Microsoft Technology Licensing LLC teaches systems, methods, and computer media for identifying related strings for search query rewriting. Session data for a user search query session in an accessed click log data is identified. It is determined whether a first additional search query in the session data is related to a first user search query based on at least one of: dwell time; a number of search result links clicked on; and similarity between web page titles or uniform resource locators (URLs). When related, the first additional search query is incorporated into a list of strings related to the first user search query. One or more supplemental strings that are related to the first user search query are also identified. The identified supplemental strings are also included in the list of strings related to the first user search query.

### SUMMARY

Developers of the present technology have appreciated at least one technical problem associated with the prior art approaches.

Developer(s) of the present technology have developed embodiments of the present technology based on a class of deep representation learning models known as a Deep Structured Semantic Model (DSSM). Briefly speaking, DSSM is a deep neural network that receives as an input queries and documents, and projects them into a common low-dimensional space where the relevance of a document given a query is computed as the distance between them. Such an approach is usually combined with word hashing techniques, which allow handling large vocabularies and scale up semantic models used by the DSSM. DSSM allows predicting relationships between two texts based on user behavior, and may predict, among others, if a document will be clicked or not.

The present technology is configured to generate features and training data for a neural network based on a modified variation of the DSSM, which may then be used by ranking algorithms, such as MatrixNet by YANDEX™, to rank documents based on their relevance to a given search query in a search engine.

More precisely, developers of the present technology have appreciated that search engine operators, such as Google™, Yandex™, Bing™ and Yahoo™, among others, have access to a large amount of user interaction data with respect to search results appearing in response to user queries, which may be used to generate annotation vectors for a document accessed via different queries. Such annotation vectors may provide useful information and features for training the modified DSSM model, neural networks and ranking algorithms.

Thus, embodiments of the present technology are directed to a method and a system for generating annotation vectors for a document.

According to a first broad aspect of the present technology, there is provided a method for generating a plurality of annotation vectors for a document, the plurality of annotation vectors to be used as features by a first machine-learning algorithm (MLA) for information retrieval, the method executable by a second MLA on a server, the server being connected to a search log database, the method comprising: retrieving, by the second MLA from the search log database, the document, the document having been indexed by a search engine server, retrieving, by the second MLA from the search log database, a plurality of queries having been used to discover the document on the search engine server, the plurality of queries having been submitted by a plurality of users, retrieving, by the second MLA from the search log database, a plurality of user interaction parameters for each one of the plurality of queries, the plurality of user interaction parameters being associated with the plurality of users, generating, by the second MLA, the plurality of annotation vectors, each annotation vector being associated with a respective query of the plurality of queries, each annotation vector of the plurality of annotation vectors including an indication of: the respective query, a plurality of query features, the plurality of query features being at least indicative of linguistic features of the respective query, and the plurality of user interaction parameters, the plurality of user interaction parameters being indicative of user behavior with the document by at least a portion of the plurality of users after having submitted the respective query on the search engine server.

In some implementations, the plurality of query features further comprises at least one of: semantic features of the query, grammatical features of the query, and lexical features of the query.

In some implementations, the method further comprises, prior to generating the plurality of annotation vectors: retrieving, by the second MLA, at least a portion of the plurality of query features from a second database.

In some implementations, the method further comprises, after retrieving at least the portion of the plurality of query features from the second database: generating, by the second MLA, at least another portion of the plurality of query features.

In some implementations, the method further comprises: generating, by the second MLA, an average annotation vector for the document, at least a portion of the average annotation vector being an average of at least a portion of the plurality of annotation vectors, and storing, by the second MLA, the average annotation vector, the average annotation vector being associated with the document.

In some implementations, the method further comprises, clustering, by the second MLA, the plurality of annotation vectors for the document into a predetermined number of clusters, the clustering being based on at least one of: the plurality of query features and the plurality of user interaction parameters, generating, by the second MLA, an average annotation vector for each of the clusters, and storing, by the second MLA, the average annotation vector for each of the clusters, the average annotation vector being associated with the document.

In some implementations, the generating the plurality of annotation vectors comprises: weighting at least one element of each annotation vector by a respective weighting factor, the respective weighting factor being indicative of a relative importance of the element for the clustering.

In some implementations, the at least one user interaction parameter for each query comprises at least one of: a number of clicks, a click-through rate (CTR), a dwell time, a click depth, a bounce rate, and an average time spent on the document.

In some implementations, the clustering is performed using one of: a k-means clustering algorithm, an expectation maximization clustering algorithm, a farthest first clustering algorithm, a hierarchical clustering algorithm, a cobweb clustering algorithm and a density clustering algorithm.

In some implementations, each cluster of the predetermined number of clusters is at least partially indicative of a different semantic meaning.

In some implementations, each cluster of the predetermined number of clusters is at least partially indicative of a similarity in user behavior.

According to a second broad aspect of the present technology, there is provided a system for generating a plurality of annotation vectors for a document, the plurality of annotation vectors to be used as features by a first machine-learning algorithm (MLA) for information retrieval, the system executable by a second MLA on the system, the system comprising: a processor, a non-transitory computer-readable medium comprising instructions, the processor, upon executing the instructions, being configured to: retrieve, from a search log database, the document, the document having been indexed by a search engine server, retrieve, by the second MLA from the search log database, a plurality of queries having been used to discover the document on the search engine server, the plurality of queries having been submitted by a plurality of users, retrieve, by the second MLA from the search log database, a plurality of user interaction parameters for each one of the plurality of queries, the plurality of user interaction parameters being associated with the plurality of users, generate, by the second MLA, the plurality of annotation vectors, each annotation vector being associated with a respective query of the plurality of queries, each annotation vector of the plurality of annotation vectors including an indication of: the respective query, a plurality of query features, the plurality of query features being at least indicative of linguistic features of the respective query, and the plurality of user interaction parameters, the plurality of user interaction parameters being indicative of user behavior with the document by at least a portion of the plurality of users after having submitted the respective query on the search engine server.

In some implementations, the plurality of query features further comprises at least one of: semantic features of the query, grammatical features of the query, and lexical features of the query.

In some implementations, the processor is further configured to, prior to generating the plurality of annotation vectors: retrieve, by the second MLA, at least a portion of the plurality of query features from a second database.

In some implementations, the processor is further configured to, after retrieving at least the portion of the plurality of query features from the second database: generate, by the second MLA, at least another portion of the plurality of query features.

In some implementations, the processor is further configured to: generate, by the second MLA, an average annotation vector for the document, at least a portion of the average annotation vector being an average of at least a portion of the plurality of annotation vectors, and store, by the second MLA, the average annotation vector, the average annotation vector being associated with the document.

In some implementations, the processor is further configured to: cluster, by the second MLA, the plurality of annotation vectors for the document into a predetermined number of clusters, the clustering being based on at least one of: the plurality of query features and the plurality of user interaction parameters, generate, by the second MLA, an average annotation vector for each of the clusters, and store, by the second MLA, the average annotation vector for each of the clusters, the average annotation vector being associated with the document.

In some implementations, to generate the plurality of annotation vectors, the processor is configured to: weight at least one element of each annotation vector by a respective weighting factor, the respective weighting factor being indicative of a relative importance of the element for the clustering.

In some implementations, the at least one user interaction parameter for each query comprises at least one of: a number of clicks, a click-through rate (CTR), a dwell time, a click depth, a bounce rate, and an average time spent on the document.

In some implementations, the clustering is performed using one of: a k-means clustering algorithm, an expectation maximization clustering algorithm, a farthest first clustering algorithm, a hierarchical clustering algorithm, a cobweb clustering algorithm and a density clustering algorithm.

In some implementations, each cluster of the predetermined number of clusters is at least partially indicative of a different semantic meaning.

In some implementations, each cluster of the predetermined number of clusters is at least partially indicative of a similarity in user behavior.

In the context of the present specification, a “server” is a computer program that is running on appropriate hardware and is capable of receiving requests (e.g. from electronic devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “electronic device” is any computer hardware that is capable of running software appropriate to the relevant task at hand. Thus, some (non-limiting) examples of electronic devices include personal computers (desktops, laptops, netbooks, etc.), smartphones, and tablets, as well as network equipment such as routers, switches, and gateways. It should be noted that a device acting as an electronic device in the present context is not precluded from acting as a server to other electronic devices. The use of the expression “a electronic device” does not preclude multiple electronic devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, etc.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. For example, an indication of a document could include the document itself (i.e. its contents), or it could be a unique document descriptor identifying a file with respect to a particular file system, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a diagram of a system implemented in accordance with non-limiting embodiments of the present technology.

FIG. 2 depicts a schematic representation of machine learning system implemented in accordance with embodiments of the present technology.

FIG. 3 depicts a schematic representation of a third MLA implemented in accordance with embodiments of the present technology.

FIG. 4 depicts a block diagram of a method for generating a plurality of annotation vectors of a document, the method executable within the system of FIG. 1.

FIG. 5 depicts a block diagram of a method for generating an average annotation vector of a document, the method executable within the system of FIG. 1.

FIG. 6 depicts a block diagram of a method for generating a plurality of average annotation vectors corresponding to annotation vector clusters, the method executable within the system of FIG. 1.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

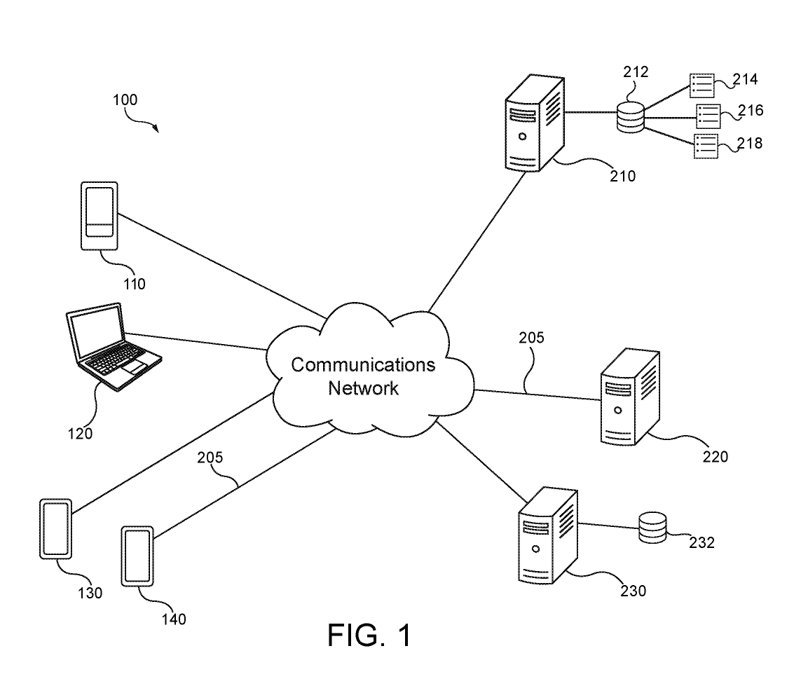

With reference to FIG. 1, there is depicted a system 100, the system 100 implemented according to embodiments of the present technology. The system 100 comprises a first client device 110, a second client device 120, a third client device 130, and a fourth client device 140 coupled to a communications network 200 via a respective communication link 205. The system 100 comprises a search engine server 210, an analytics server 220 and a training server 230 coupled to the communications network 200 via their respective communication link 205.

As an example only, the first client device 110 may be implemented as a smartphone, the second client device 120 may be implemented as a laptop, the third client device 130 may be implemented as a smartphone and the fourth client device 140 may be implemented as a tablet. In some non-limiting embodiments of the present technology, the communications network 200 can be implemented as the Internet. In other embodiments of the present technology, the communications network 200 can be implemented differently, such as any wide-area communications network, local-area communications network, a private communications network and the like.

How the communication link 205 is implemented is not particularly limited and will depend on how the first client device 110, the second client device 120, the third client device 130 and the fourth client device 140 are implemented. Merely as an example and not as a limitation, in those embodiments of the present technology where at least one of the first client device 110, the second client device 120, the third client device 130 and the fourth client device 140 is implemented as a wireless communication device (such as a smart-phone), the communication link 205 can be implemented as a wireless communication link (such as but not limited to, a 3G communications network link, a 4G communications network link, a Wireless Fidelity, or WiFi® for short, Bluetooth® and the like). In those examples, where at least one of the first client device 110, the second client device 120, the third client device 130 and the fourth client device 140 are implemented respectively as laptop, smartphone, tablet computer, the communication link 205 can be either wireless (such as the Wireless Fidelity, or WiFi® for short, Bluetooth® or the like) or wired (such as an Ethernet based connection).

It should be expressly understood that implementations for the first client device 110, the second client device 120, the third client device 130, the fourth client device 140, the communication link 205 and the communications network 200 are provided for illustration purposes only. As such, those skilled in the art will easily appreciate other specific implementational details for the first client device 110, the second client device 120, the third client device 130, the fourth client device 140 and the communication link 205 and the communications network 200. As such, by no means, examples provided herein above are meant to limit the scope of the present technology.

While only four client devices 110, 120, 130 and 140 are illustrated (all are shown in FIG. 1), it is contemplated that any number of client devices 110, 120, 130 and 140 could be connected to the system 100. It is further contemplated that in some implementations, the number of client devices 110, 120, 130 and 140 included in the system 100 could number in the tens or hundreds of thousands.

Also coupled to the communications network 200 is the aforementioned search engine server 210. The search engine server 210 can be implemented as a conventional computer server. In an example of an embodiment of the present technology, the search engine server 210 can be implemented as a Dell™ PowerEdge™ Server running the Microsoft™ Windows Server™ operating system. Needless to say, the search engine server 210 can be implemented in any other suitable hardware and/or software and/or firmware or a combination thereof. In the depicted non-limiting embodiment of present technology, search engine server 210 is a single server. In alternative non-limiting embodiments of the present technology, the functionality of the search engine server 210 may be distributed and may be implemented via multiple servers. In some embodiments of the present technology, the search engine server 210 is under control and/or management of a search engine operator. Alternatively, the search engine server 210 can be under control and/or management of a service provider.

Generally speaking, the purpose of the search engine server 210 is to (i) execute searches (details will be explained herein below); (ii) execute analysis of search results and perform ranking of search results; (iii) group results and compile the search result page (SERP) to be outputted to an electronic device (such as one of the first client device 110, the second client device 120, the third client device 130 and the fourth client device 140).

How the search engine server 210 is configured to execute searches is not particularly limited. Those skilled in the art will appreciate several ways and means to execute the search using the search engine server 210 and as such, several structural components of the search engine server 210 will only be described at a high level. The search engine server 210 may maintain a search log database 212.

In some embodiments of the present technology, the search engine server 210 can execute several searches, including but not limited to, a general search and a vertical search.

The search engine server 210 is configured to perform general web searches, as is known to those of skill in the art. The search engine server 210 is also configured to execute one or more vertical searches, such as an images vertical search, a music vertical search, a video vertical search, a news vertical search, a maps vertical search and the like. The search engine server 210 is also configured to, as is known to those of skill in the art, execute a crawler algorithm—which algorithm causes the search engine server 210 to “crawl” the Internet and index visited web sites into one or more of the index databases, such as the search log database 212.

The search engine server 210 is configured to generate a ranked search results list, including the results from the general web search and the vertical web search. Multiple algorithms for ranking the search results are known and can be implemented by the search engine server 210.

Just as an example and not as a limitation, some of the known techniques for ranking search results by relevancy to the user-submitted search query are based on some or all of: (i) how popular a given search query or a response thereto is in searches; (ii) how many results have been returned; (iii) whether the search query contains any determinative terms (such as “images”, “movies”, “weather” or the like), (iv) how often a particular search query is typically used with determinative terms by other users; and (v) how often other uses performing a similar search have selected a particular resource or a particular vertical search results when results were presented using the SERP. The search engine server 210 can thus calculate and assign a relevance score (based on the different criteria listed above) to each search result obtained in response to a user-submitted search query and generate a SERP, where search results are ranked according to their respective relevance scores. In the present embodiment, the search engine server 210 may execute a plurality of machine learning algorithms for ranking documents and/or generate features for ranking documents.

The search engine server typically maintains the above-mentioned search log database 212.

Generally, the search log database 212 may maintain an index 214, a query log 216, and a user interaction log 218.

The purpose of the index 214 is to index documents, such as, but not limited to, web pages, images, PDFs, Word™ documents, PowerPoint™ documents, that have been crawled (or discovered) by the crawler of the search engine server 210. As such, when a user of one of the first client device 110, the second client device 120, the third client device 130, and the fourth client device 140 inputs a query and performs a search on the search engine server 210, the search engine server 210 analyzes the index 214 and retrieves documents that contain terms of the query, and ranks them according to a ranking algorithm.

The purpose of the query log 216 is to log searches that were made using the search engine server 210. The query log 216 may include a list of queries with their respective terms, with information about documents that were listed by the search engine server 210 in response to a respective query, a timestamp, and may also contain a list of users identified by anonymous IDs and the respective documents they have clicked on after submitting a query. In some embodiments, the query log 216 may be updated every time a new search is performed on the search engine server 210. In other embodiments, the query log 216 may be updated at predetermined times. In some embodiments, there may be a plurality of copies of the query log 216, each corresponding to the query log 216 at different points in time.

The user interaction log 218 may be linked to the query log 216, and list user interaction parameters as tracked by the analytics server 220 after a user has submitted a query and clicked on one or more documents in a SERP on the search engine server 210. As a non-limiting example, the user interaction log 218 may contain reference to a document, which may be identified by an ID number or an URL, a list of queries, where each query of the list of queries is associated with a plurality of user interaction parameters, which will be described in more detail in the following paragraphs. The plurality of user interaction parameters may generally be tracked and compiled by the analytics server 220, and in some embodiments may be listed for each individual user.

In some embodiments, the query log 216 and the user interaction log 218 may be implemented as a single log.

Also coupled to the communications network 200 is the above-mentioned analytics server 220. The analytics server 220 can be implemented as a conventional computer server. In an example of an embodiment of the present technology, the analytics server 220 can be implemented as a Dell™ PowerEdge™ Server running the Microsoft™ Windows Server™ operating system. Needless to say, the analytics server 220 can be implemented in any other suitable hardware and/or software and/or firmware or a combination thereof. In the depicted non-limiting embodiment of present technology, the analytics server 220 is a single server. In alternative non-limiting embodiments of the present technology, the functionality of the analytics server 220 may be distributed and may be implemented via multiple servers. In other embodiments, the functionality of the analytics server 220 may be performed completely or in part by the search engine server 210. In some embodiments of the present technology, the analytics server 220 is under control and/or management of a search engine operator. Alternatively, the analytics server 220 can be under control and/or management of another service provider.

Generally speaking, the purpose of the analytics server 220 is to track user interactions with search results provided by the search engine server 210 in response to user requests (e.g. made by users of one of the first client device 110, the second client device 120, the third client device 130 and the fourth client device 140). The analytics server 220 may track user interactions or click-through data when users perform general web searches and vertical web searches on the search engine server 210. The user interactions may be tracked in the form of user interaction parameters by the analytics server 220.

Non-limiting examples of user interaction parameters tracked by the analytics server 220 include:
Session Time: Mean session time, measured in seconds.
Log Session Time: Mean logarithmic value of session times.
Queries: The number of queries submitted by a user.
Clicks: The number of clicks performed by a user.
Clicks per Query: The average number of clicks per query for the user.
Click-through rate (CTR): Number of clicks on an element divided by the number of times the element is shown (impressions).
Daily Active Users (DAU): Number of unique users engaging with the service during a day.
Average daily sessions per user (S/U): u S(u) |u|, where S(u) indicates user u's daily session number and |u| is the total number of users on that day.
Average unique queries per session (UQ/S): s UQ(s) |s|, where UQ(s) represents the number of unique queries within session s, and |s| the total number of sessions on that day.
Average session length per user (SL/U): the total number of queries within a session, averaged over each user.
Percentage of navigational queries per user (%-Nav-Q/U): click positions: if over n % of all clicks for a query is concentrated on top-3 ranked URLs, this query is considered to be navigational. Otherwise it is treated as informational. The value of n may be set to 80.
Average query length per user (QL/U): the query length measures the number of words in a user query.
Average query success rate per user (QSuccess/U): a user query is said to be successful if the user clicks one or more results and stays at any of them for more than 30 seconds.
Average query Click Through Rate (CTR): the CTR for a query is 1 if there is one or more clicks, otherwise 0.
Average query interval per user (QI/U): the average time difference between two consecutive user queries within a user session.
Dwell time: time a user spends on a document before returning to the SERP.

Naturally, the above list is non-exhaustive and may include other types of user interaction parameters without departing from the scope of the present technology.

The analytics server 220 may transmit the tracked user interaction parameters to the search engine server 210 such that it can be stored in the user interaction log 218. In some embodiments, the analytics server 220 may store the user interaction parameters and associated search results locally in an user interaction log (not depicted). In alternative non-limiting embodiments of the present technology, the functionality of the analytics server 220 and the search engine server 210 can be implemented by a single server.

Also coupled to the communications network is the above-mentioned training server 230. The training server 230 can be implemented as a conventional computer server. In an example of an embodiment of the present technology, the training server 230 can be implemented as a Dell™ PowerEdge™ Server running the Microsoft™ Windows Server™ operating system. Needless to say, the training server 230 can be implemented in any other suitable hardware and/or software and/or firmware or a combination thereof. In the depicted non-limiting embodiment of present technology, the training server 230 is a single server. In alternative non-limiting embodiments of the present technology, the functionality of the training server 230 may be distributed and may be implemented via multiple servers. In the context of the present technology, the training server 230 may implement in part the methods and system described herein. In some embodiments of the present technology, the training server 230 is under control and/or management of a search engine operator. Alternatively, the training server 230 can be under control and/or management of another service provider.

Generally speaking, the purpose of the training server 230 is to train one or more machine learning algorithms (MLAs) used by the search engine server 210, the analytics server 220 and/or other servers (not depicted) associated with the search engine operator. The training server 230 may, as an example, train one or more MLAs associated with the search engine provider for optimizing general web searches, vertical web searches, providing recommendations, predicting outcomes, and other applications. The training and optimization of the MLAs may be executed at predetermined periods of time, or when deemed necessary by the search engine provider.

In the embodiments illustrated herein, the training server 230 may be configured to train (1) a first MLA for ranking documents on the search engine server 210, (2) a second MLA for generating features that may be used by the first MLA, and (3) a third MLA for generating annotations vectors that may be used by at least one of the first MLA and the second MLA. The first MLA, the second MLA and the third MLA will be described in more detail in the following paragraphs. While the description refers to general web searches for documents such as web pages, the present technology may also be applied at least partially to vertical searches and to other types of documents, such as image results, videos, music, news, and other types of searches.

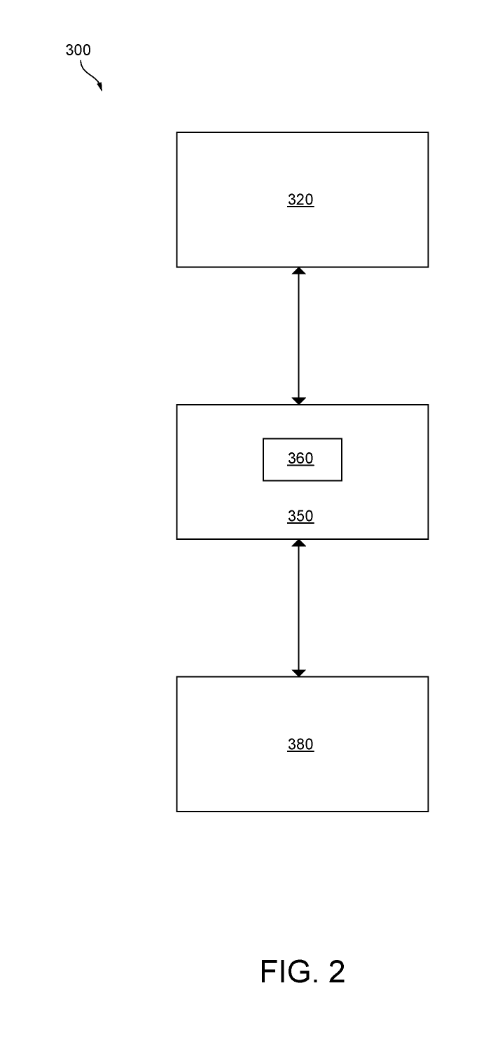

Now turning to FIG. 2, a machine learning system 300 is illustrated in accordance with non-limiting embodiments of the present technology. The machine learning system 300 comprises a first MLA 320, a second MLA 350 and a third MLA 380.

The first MLA 320 may generally be used for ranking search results on the search engine server and may implement a gradient boosted decision tree algorithm (GBRT). Briefly speaking, GBRT is based on decision trees, whereby a prediction model in the form of an ensemble of trees is generated. The ensemble of trees is built in a stage-wise manner Each subsequent decision tree in the ensemble of decision trees focuses training on those previous decision tree iterations that were “weak learners” in the previous iteration(s) of the decision trees ensemble (i.e. those that are associated with poor prediction/high error). Boosting is a method aimed at enhancing prediction quality of an MLA. In this scenario, rather than relying on a prediction of a single trained algorithm (i.e. a single decision tree) the system uses many trained algorithms (i.e. an ensemble of decision trees), and makes a final decision based on multiple prediction outcomes of those algorithms.

In boosting of decision trees, the first MLA 320 first builds a first tree, then a second tree, which enhances the prediction outcome of the first tree, then a third tree, which enhances the prediction outcome of the first two trees and so on. Thus, the first MLA 320 in a sense is creating an ensemble of decision trees, where each subsequent tree is better than the previous, specifically focusing on the weak learners of the previous iterations of the decision trees. Put another way, each tree is built on the same training set of training objects, however training objects, in which the first tree made “mistakes” in predicting are prioritized when building the second tree, etc. These “tough” training objects (the ones that previous iterations of the decision trees predict less accurately) are weighted with higher weights than those where a previous tree made satisfactory prediction.

The first MLA 320 may thus be used for classification and/or regression and/or ranking by the search engine server 210. The first MLA 320 may be the main ranking algorithm of the search engine server 210, or may be part of the ranking algorithm of the search engine server 210.

The second MLA 350 may execute a modified deep structured semantic model (DSSM) 360. Generally, the purpose of the second MLA 350 is to enrich document features such that the features may be used by the first MLA 320 for ranking documents based on a relevance score. The second MLA 350 is configured to train the modified DSSM 360 on at least a search query and a title of a document. The modified DSSM 360 generally receives as an input word unigrams (entire words), word bigrams (pairs of words) and word trigrams (sequences of three words). In some embodiments, the modified DSSM 360 may also receive as an input word n-grams where n is greater than 3. The modified DSSM 360 is also trained on user interaction parameters, such as, but not limited to: click/no-click which may be weighted by dwell time or log(dwell time), depth of the click, click abandonment, number of unique clicks per session, CTR, etc. The output of the second MLA 350 may be used as an input by the first MLA 320.

Generally, the purpose of the third MLA 380 is to generate annotation vectors for documents, which may be used as an input by at least one of the first MLA 320 and the second MLA 350. In the present embodiment, the third MLA 380 generates annotation vectors that may be used by the modified DSSM 360 of the second MLA 350, as an example, for matching queries and documents, for comparing queries and documents, and for making predictions on user interaction with a given document. In some embodiments, the third MLA 380 may be part of the second MLA 350. The annotation vectors may be used for training at least one of the first MLA 320 and the second MLA 350, or may be directly used as features by the first MLA 320 for ranking documents in response to a query. How the third MLA 380 generates annotation vectors for one or more documents will be described in the following paragraphs.

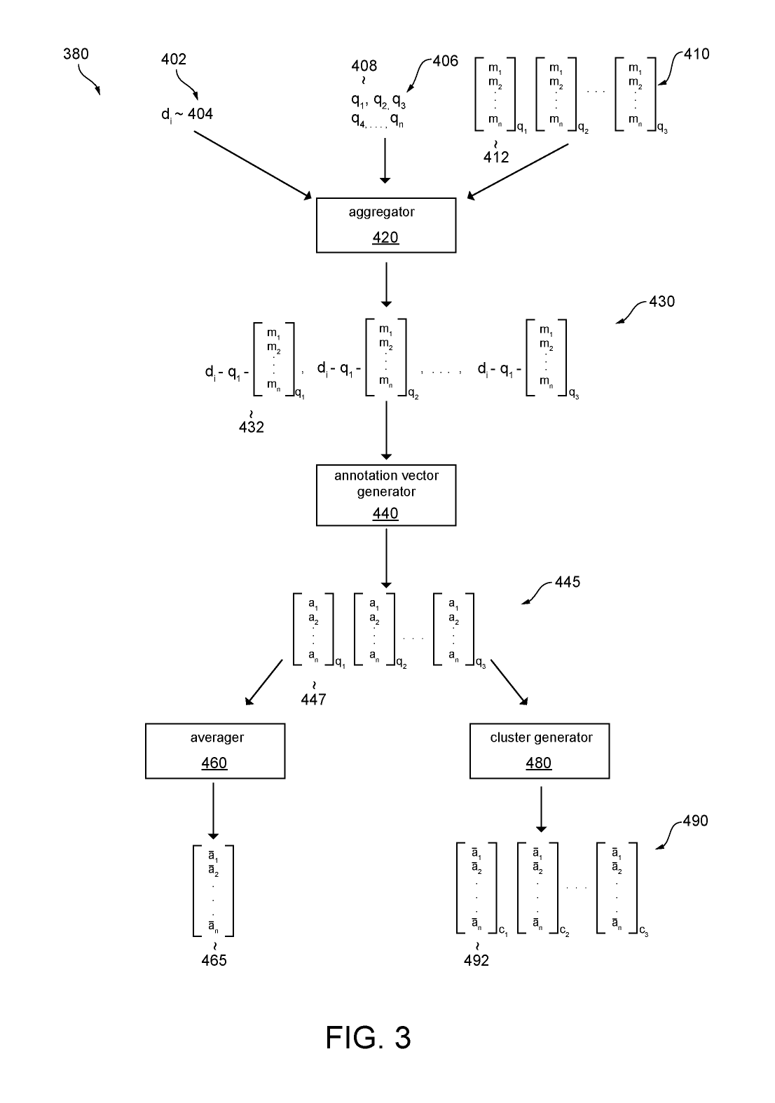

Now turning to FIG. 3, the third MLA 380 is illustrated in accordance with non-limiting embodiments of the present technology. The third MLA 380 may be executed by the training server 230.

The third MLA 380 comprises an aggregator 420, an annotation vector generator 440, and optionally an averager 460 and/or a cluster generator 480.

The aggregator 420 of the third MLA 380 may generally be configured to retrieve, aggregate, filter and associate together queries, documents and user interaction parameters.

For the purpose of simplification of the description of the present technology, in the illustrated embodiment, the aggregator 420 may retrieve, from the query log 216 of the search log database 212 of the search engine server 210, an indication of a document 402, the indication of the document 402 including a single document 404. However, depending on how the training server 230 is configured, the number of documents in the indication of the document 402 may be in the hundreds, thousands or more, and the third MLA 380 may process the documents sequentially or in parallel.

Generally speaking, the document 404 may be a reference to a document that is indexed by the search engine server 210 and that may appear in a SERP in response to different queries submitted by users, such as one of the users (not depicted) of the first client device 110, the second client device 120, the third client device 130, and the fourth client device 140. Generally, the indication of the document 402 may be an identifier for identifying the document 404 in the index 214, the query log 216 and the user interaction log 218. As a non-limiting example, the document 404 of the indication of the document 402 may be a popular Wikipedia™ page, such as a Wikipedia™ page about Angelina Jolie.

Based on the indication of the document 402, the aggregator 420 may retrieve an indication of queries 406 from the query log 216 of the search log database 212 of the search engine server 210, the indication of queries 406 (having a plurality of queries 408) being associated with the document 404 of the indication of the document 402. The manner in which the indication of queries 406 is implemented is not limited, and depends on how the search log database 212, the index 214, the query log 216 and the user interaction log 218 are configured.

Generally, the indication of the queries 406 includes a plurality of queries associated with the document 404, where each query may be a different query that has been used to access the document 404 by users on the search engine server 210, as recorded in the query log 216. Naturally, a given query may include a plurality of terms, and the aggregator 420 may consider the entire query and the terms composing the query, e.g. a query “Angelina Jolie actress” has 3 terms, “Angelina”, “Jolie” and “actress”.

Continuing with the preceding non-limiting example, where the document 404 is the Angelina Jolie Wikipedia™ page, the queries associated with the document 404 retrieved from the query log 216 of the search log database 212 of the search engine server 210 may be the following: “Angelina”, “Angelina Jolie”, “Lara Croft”, “Lara Croft Angelina”, “Maleficient”, “Mr. and Mrs. Smith”, “Tomb Raider”, “Angelina Voight”, “Lara Croft Movie”, “Beautiful actress”, “unbroken movie”, “Tomb Raider actress”, “Mighty Heart movie”, “United Nation refugee envoy”, “Brad Pitt wife”, “John Voight”, “most beautiful women”, “celebrity child”, “billy bob thornton”, “academy award best actress”. The number of queries in the plurality of queries 406 is not limited, and may be in the hundreds or thousands, depending on the popularity of the document and how the ranking algorithm of the search engine server 210 executes the ranking. The SERP on which the document 404 appears in response to one of the queries 408 is inconsequential, however in some embodiments, the aggregator 420 may only select queries 408 based on a SERP page threshold or a relevance score threshold, e.g. if the document appears on the 100^{th} SERP page in response to the query 408, the query 408 may not be considered by the aggregator 420.

The aggregator 420 may also retrieve a set of user interaction parameters 410 from the user interaction log 418 of the search log database 212 of the search engine server 210, the set of user interaction parameters 410 associated with the document 404 and the indication of queries 406. The set of user interaction parameters 410 includes a plurality of user interaction parameters 412 corresponding to each query 408 in the indication of queries 406. Generally, each of the plurality of user interaction parameters 412 may be indicative of user behavior of one or more users after having submitted a respective query, and clicked on the document 404 during a search session on the search engine server 210, as an example via one of the first client device 110, the second client device 120, the third client device 130, and the fourth client device 140.

In some embodiments, depending on how the third MLA 380 is configured, the aggregator 420 may choose specific user interaction parameters that are relevant to the task at hand, and may not necessarily retrieve all user interaction parameters tracked by the analytics server 220 and stored in the user interaction log 218.

Generally, the user interaction parameters may be an aggregate of user interaction parameters from a plurality of users, and may not be individual user interaction parameters. In some embodiments, where at least one of the first MLA 320, the second MLA 350 and the third MLA 380 is configured for personalized searches, the aggregator 420 may aggregate user interaction parameters for a single user.

The aggregator 420 may then associate the indication of the document 402, the indication of queries 406 and the set of user interaction parameters 410 and output a set of associated queries and user interaction parameters 430, the set of associated queries and user interaction parameters 430 including a plurality of associated query-user interaction parameters 432.

The annotation vector generator 440 of the third MLA 380 may receive as an input the set of associated queries and user interaction parameters 430 and output a set of annotation vectors 445.

Generally speaking, the purpose of the annotation vector generator 440 is to generate an annotation vector 447 for each associated query-user interaction parameters 432 in the set of associated queries and user interaction parameters 430 used to access the document 404. Each annotation vector 447 may include all the information contained in each of the associated query-user interaction parameters 432. Each annotation vector 447 may include an indication of the respective query 408 used to access the document 404, a plurality of query features of the respective query 408, the plurality of query features being at least partially indicative of linguistic features of the respective query 408, and the respective plurality of user interaction parameters 412.

The annotation vector generator 440 may retrieve and/or generate at least a portion of the plurality of query features in each annotation vector 447 for the document 404. The annotation vector generator 440 may generate query features being at least indicative of linguistic features of the respective query. The linguistic features may include semantic features of the query, grammatical features of the query, and lexical features of the query.

The annotation vector generator 440 of the third MLA 380 may be configured to generate features via various algorithms or retrieve the different types of features from a linguistic database, such as, but not limited to, WordNet® or a thesaurus type dictionary.

In some embodiments, a separate MLA (not depicted) may also be trained to extract linguistic features from queries and terms, and perform natural language processing (NLP). As a non-limiting example, NLP techniques such as lemmatization, morphological segmentation, part-of-speech tagging, parsing, sentence breaking, stemming, word segmentation, terminology extraction, named entity recognition (NER), and topic segmentation and recognition, among others may be used.

Semantic analysis of the queries and terms may also be performed by the annotation vector generator 440 or a separate MLA (not depicted), which generally consists in decomposing queries and search terms into attributes based on how they are expressed linguistically, and the conceptual meaning of the queries and terms may be considered. Semantic relations among queries and terms may also be considered.

Semantic features of the query may include semantic roles, category features, and property features. As a non-limiting example, as semantic role may relate to an agent, theme, experiencer, instrument, recipient or time. A category feature may relate to a category of the queries and terms, which categories may be predetermined by the third MLA 380. A non-limiting example a property feature may include a morpheme, a word, and a sentence.

Grammatical features of the query may include gender, number, person, case, number, tense, aspect, transitivity, and inflectional class.

Lexical features of the query and terms may include adjectives, adverbs, conjuctions, particles, adpositions, and verbs. Lexical features may also include lexical relations such as homophony, homonymy, polysemy, synonymy, antonymy, hyponymy, metonymy, and collocation.

Furthermore, synonyms, antonyms, and different spelling of queries and terms may also be considered by the annotation vector generator 440.

The annotation vector generator 440 may then generate an annotation vector 447 for each query, the annotation vector 447 including an indication of: the respective query, the plurality of query features, and the plurality of user interaction parameters. The manner in which the annotation vector 447 is generated and represented is not limited, and depends on how the third MLA 380 and/or the second MLA 350 are implemented.

In some embodiments, where a supervised learning approach is used with the third MLA 380, the third MLA 380 may be trained to generate annotation vectors based on examples of documents and respective annotation vectors that have been reviewed and/or provided by assessors. In other embodiments, the annotation vectors may be assessed based on the output of the second MLA 350 and/or the first MLA 320.

Thus, for a document, such as the document 404, the annotation vector generator 440 may generate a plurality of annotation vectors 445, each annotation vector 447 corresponding to a different query used to access the document 404.

The third MLA 380 may store the plurality of annotation vectors 445 in the training database 232 of the training server 230, the plurality of annotation vectors 445 being associated with the document 404.

In some embodiments, the plurality of annotation vectors 445 may be received as an input in the averager 460 of the cluster generator 480. Generally, the plurality of annotation vectors 445 may be received as an input in the averager 460 when queries of the set of associated queries and user interaction parameters 430 have a certain degree of similarity, which may be determined by the third MLA 380 in different ways, as an example based on the query features of each query. The plurality of annotation vectors 445 may also be input in the averager 460 when the number of annotation vectors in the plurality of annotation vectors 445 is under a predetermined threshold, i.e. there may be a higher probability of having semantically different queries when the number of queries leading to a same document 404 is high, such as in the thousands, and lower probability of having semantically similar queries when the number of queries is lower.

Generally, the purpose of the averager 460 is to obtain a single average annotation vector 465 that is indicative of at least a portion of the queries used to access the document 404. Such an approach allows saving storage space and computational resources by having a single average annotation vector instead of a plurality of annotation vectors 445 to store (which may number in the thousands or more for a single document).

The averager 460 may compute the average of each element of the plurality of annotation vectors 445 to obtain a single average annotation vector 465. Thus, the first element of the single average annotation vector 465 may be an average of all of the first elements of the plurality of annotation vectors 445, the second of the single average annotation vector 465 may be an average of all of the second elements of the plurality of annotation vectors 445, and so on. In some embodiments, the averager 460 may ignore some elements or apply other types of functions to elements, depending on the type of user interaction parameters included in the plurality of annotation vectors 445.

The averager 460 may output the single average annotation vector 465. The single average annotation vector 465 may be stored in the training database 232 of the training server 230, where it is associated with the document 404.

In some embodiments, the plurality of annotation vectors 445 may be received as an input in the cluster generator 480. Generally, the plurality of annotation vectors 445 may be received as an input in the cluster generator 480 when queries of the set of associated queries and user interaction parameters 430 have a certain degree of dissimilarity (or a low degree of similarity), which may be determined, as an example, by the third MLA 380 based on the query features. However, in some embodiments, the plurality of annotation vectors 445 may be received as an input in the cluster generator 480 regardless of the degree of similarity of the queries of the set of associated queries and user interaction parameters 430.

Generally, the purpose of the cluster generator 480 is to generate a plurality of clusters based on the elements of the plurality of annotation vectors 445, each cluster corresponding to groups of annotation vectors having features that are deemed similar or close by the cluster generator 480. In some embodiments, weights may be assigned to certain elements of each annotation vector 447 such that the cluster generator 480 gives more relative importance to particular features during the clustering.

As a non-limiting example, using the k-means algorithm, the cluster generator 480 may execute the clustering iteratively, and assign each annotation vector 447 to a given cluster, based on the features or elements of the annotation vector 447.

In some embodiments, the cluster generator 480 may not consider every element of the plurality of annotation vectors 445 and/or give more weight to certain elements that may be more representative of queries, linguistic features and user interaction parameters in each annotation vector 447.

In some embodiments, the number of clusters to generate may be predetermined by developer(s). In other embodiments, the number of clusters may be predetermined based on a number of queries and the similarity of queries. As a non-limiting example, the plurality of annotation vectors 445 may be divided into five clusters, each cluster having a group of annotation vectors that are considered ‘similar’ or related by the cluster generator 480 based on the elements of the plurality of annotation vectors 445, such as the semantic meaning and/or user behavior.

Clustering methods are generally known in the art. As an example, the clustering may be performed by the cluster generator 480 using one of: a k-means clustering algorithm, a fuzzy c-means clustering algorithm, hierarchical clustering algorithms, Gaussian clustering algorithms, quality threshold clustering algorithms, and others, as it is known in the art.

The cluster generator 480 may average the annotation vectors part of each cluster to obtain a plurality of average annotation vectors 490. Each average annotation vector 492 may represent a given cluster.

The plurality of average annotation vectors 490 then be stored in the training database 232 of the training server 230, where the plurality of average annotation vectors 490 is associated with the document 404.

Generally, the averager 460 may be used when a single average annotation vector is needed, such as when queries leading to the document 404 are closely related to each other, while the cluster generator 480 may be used when at least two average annotation vectors are needed, such as when queries leading to the document 404 are not closely related to each other.

As such, the one or more annotation vectors may be used directly as ranking features associated with documents by a ranking algorithm of a search engine, such as the first MLA 320 of the search engine server 310. The one or more annotation vectors may also be used as features of the modified DSSM 360 of the second MLA 350, as an example when comparing queries, documents, and user interaction parameters.

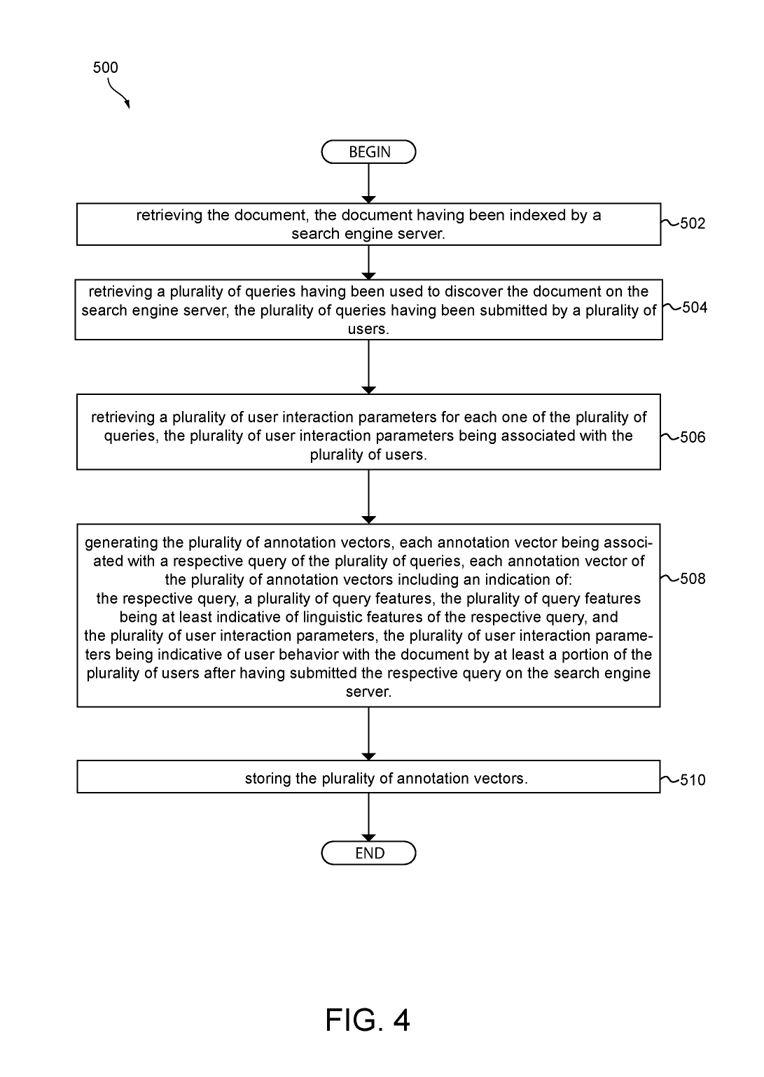

Now turning to FIG. 4, a flowchart of a method 500 of generating a set of training objects for a machine learning algorithm is illustrated. The method 500 is executed by the first MLA 320 of the training server 230.

The method 500 may begin at step 502.

STEP 502: retrieving the document, the document having been indexed by a search engine server.

At step 502, the aggregator 420 of the first MLA 320 may retrieve the indication of documents 402 comprising the document 404, the document 404 having been indexed by the crawler of the search engine server 210 in the index 214 of the search engine server 210.

The method 500 may then advance to step 504.

STEP 504: retrieving a plurality of queries having been used to discover the document on the search engine server, the plurality of queries having been submitted by a plurality of users.

At step 504, the aggregator 420 of the third MLA 380 may retrieve an indication of queries 406, the indication of queries 406 including a plurality of queries 408 having been submitted by users of the first client device 110, the second client device 120, the third client device 130, and the fourth client device 140.

The method 500 may then advance to step 506.

STEP 506: retrieving a plurality of user interaction parameters for each one of the plurality of queries, the plurality of user interaction parameters being associated with the plurality of users.

At step 506, the aggregator 420 of the third MLA 380 may retrieve, from the user interaction log 218 of the search log database 212 of the search engine server 210, a set of user interaction parameters 410, the set of user interaction parameters 410 including a plurality of user interaction parameters 412 for each one of the plurality of queries 408, the plurality of user interaction parameters 412 being associated with the plurality of users of the first client device 110, the second client device 120, the third client device 130, and the fourth client device 140. The plurality of user interaction parameters 412 for each query may include: a number of clicks, a click-through rate (CTR), a dwell time, a click depth, a bounce rate, an average time spent on the document, among others.

The method 500 may then advance to step 506.

STEP 508: generating the plurality of annotation vectors, each annotation vector being associated with a respective query of the plurality of queries, each annotation vector of the plurality of annotation vectors including an indication of:
the respective query,
a plurality of query features, the plurality of query features being at least indicative of linguistic features of the respective query, and
the plurality of user interaction parameters, the plurality of user interaction parameters being indicative of user behavior with the document by at least a portion of the plurality of users after having submitted the respective query on the search engine server.

At step 508, the annotation vector generator 440 of third MLA 380 may generate a plurality of annotation vectors 445 based on the set of associated queries and user interaction parameters 430. Each annotation vector 447 of the plurality of annotation vectors 445 may comprise the respective query 408, a plurality of query features, the plurality of query features being at least indicative of linguistic features of the respective query, and the plurality of user interaction parameters 410, the plurality of user interaction parameters 410 being indicative of user behavior with the document 404 by at least a portion of the plurality of users after having submitted the respective query 408 on the search engine server 210. The plurality of query features comprises at least one of semantic features of the query, grammatical features of the query, and lexical features of the query. In some embodiments, the annotation vector generator 440 may weight at least one element of each annotation vector 447 by a respective weighting factor, the respective weighting factor being indicative of a relative importance of the element for the clustering. In some embodiments, the annotation vector generator 440 may retrieve at least a portion of the plurality of query features from a second database. In some embodiments, the annotation vector generator 440 may generate at least another portion of the plurality of query features.

The method 500 may then optionally advance to step 510. In some embodiments the method 500 may advance to method 600 or method 700.

STEP 510: storing the plurality of annotation vectors.

At step 510, the third MLA 380 may store the plurality of annotation vectors 445 generated by the annotation vector generator 440 in the training database 232 of the training server 230, where the plurality of annotation vectors 445 is associated with the document 404.

The method 500 may then end.

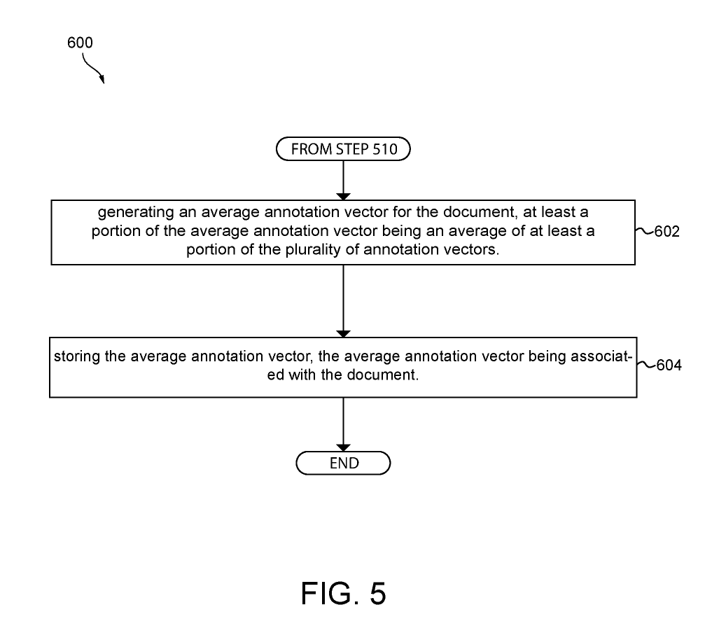

Now turning to FIG. 5, a flowchart of a method 600 of generating an average annotation vector 465 based on the plurality of annotation vectors 445 is illustrated. The method 600 is executed by the first MLA 320 of the training server 230.

STEP 602: generating an average annotation vector for the document, at least a portion of the average annotation vector being an average of at least a portion of the plurality of annotation vectors.

At step 602, the averager 460 of the third MLA 380 may generate average annotation vector 465 for the document 404, at least a portion of the average annotation vector 465 being an average of at least a portion of the plurality of annotation vectors 445.

The method 600 may then advance to step 604.

STEP 604: storing the average annotation vector, the average annotation vector being associated with the document.

At step 604, the third MLA 380 may store the average annotation vector 465 in the training database 232 of the training server 230.

The method 600 may then end.

In some embodiments, the method 600 may be followed by a method 700.

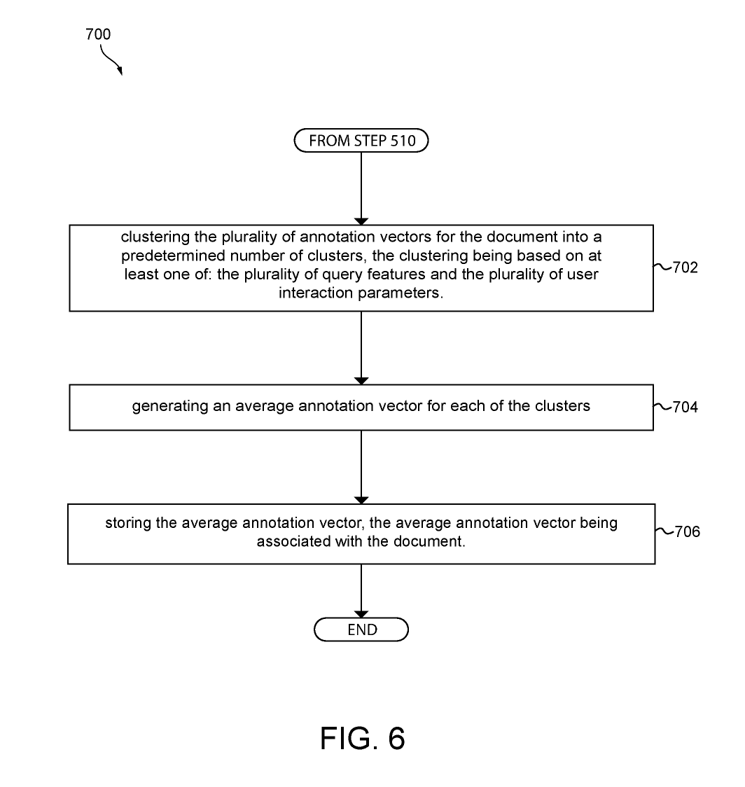

Now turning to FIG. 6, a flowchart of the method 700 of generating an average annotation vector 465 for clusters based on the plurality of annotation vectors 445 is illustrated. The method 700 is executed by the first MLA 320 of the training server 230.

The method 700 may begin at step 702.

STEP 702: clustering, the plurality of annotation vectors for the document into a predetermined number of clusters, the clustering being based on at least one of: the plurality of query features and the plurality of user interaction parameters.

At step 702, the cluster generator 480 of the third MLA 380 may cluster the plurality of annotation vectors 445 for the document 404 into a predetermined number of clusters, the clustering being based on at least one of: the plurality of query features and the plurality of user interaction parameters. The clustering may be performed using one of: a k-means clustering algorithm, an expectation maximization clustering algorithm, a farthest first clustering algorithm, a hierarchical clustering algorithm, a cobweb clustering algorithm and a density clustering algorithm.

The method 700 may then advance to step 704.

STEP 704: generating, by the second MLA, an average annotation vector for each of the clusters.

At step 704, the cluster generator 480 of the third MLA 380 may generate a plurality of average annotation vectors 490, the plurality of average annotation vectors 490 including an average annotation vector 492 for each of the clusters.

The method 700 may advance to step 706.

STEP 706: storing the average annotation vector for each of the clusters, the average annotation vector being associated with the document.

At step 706, the third MLA 380 may store the plurality of average annotation vectors 490 in the training database 232 of the training server 230, the plurality of average annotation vectors 490 including the average annotation vector 492 for each of the clusters, the average annotation vector 492 being associated with the document 404.

The method 700 may then end.

Generally, the method 600 may be executed when a single average annotation vector is needed, such as when queries leading to the document 404 are closely related to each other, while the method 700 may be used when at least two average annotation vectors are needed, such as when queries leading to the document 404 are not closely related to each other. The methods 500, 600 and 700 may be executed in an offline mode by the training server 230.

The plurality of average annotation vectors 490 may then be used by the first MLA 320 and/or the second MLA 350 as training features, and/or as features for ranking a document. As a non-limiting example, the second MLA 350 or another MLA implementing neural networks may use the annotation vectors to determine a proximity between different queries, and predict a user interaction feature such as a dwell time for a document.

The present technology may allow for more efficient processing in information retrieval applications, which may allow saving computational resources and time on both client devices and server by presenting more relevant results to users in response to queries.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Some of these steps and signal sending-receiving are well known in the art and, as such, have been omitted in certain portions of this description for the sake of simplicity. The signals can be sent-received using optical means (such as a fibre-optic connection), electronic means (such as using wired or wireless connection), and mechanical means (such as pressure-based, temperature based or any other suitable physical parameter based).

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method for generating a plurality of annotation vectors for a document, the plurality of annotation vectors to be used as features by a first machine-learning algorithm (MLA) for information retrieval, the method executable by a second MLA on a server, the server being connected to a search log database, the method comprising:
retrieving, by the second MLA from the search log database, the document, the document having been indexed by a search engine server;
retrieving, by the second MLA from the search log database, a plurality of queries having been used to discover the document on the search engine server, the plurality of queries having been submitted by a plurality of users;
retrieving, by the second MLA from the search log database, a plurality of user interaction parameters for each one of the plurality of queries, the plurality of user interaction parameters being associated with the plurality of users;
generating, by the second MLA, the plurality of annotation vectors, each annotation vector being associated with a respective query of the plurality of queries, each annotation vector of the plurality of annotation vectors including an indication of:
the respective query,
a plurality of query features, the plurality of query features being at least indicative of linguistic features of the respective query, and
the plurality of user interaction parameters, the plurality of user interaction parameters being indicative of user behavior with the document by at least a portion of the plurality of users after having submitted the respective query on the search engine server.

2. The method of claim 1, wherein the plurality of query features further comprises at least one of: semantic features of the query, grammatical features of the query, and lexical features of the query.

3. The method of claim 2, wherein the method further comprises, prior to generating the plurality of annotation vectors:
retrieving, by the second MLA, at least a portion of the plurality of query features from a second database.

4. The method of claim 2, wherein the method further comprises, after retrieving at least the portion of the plurality of query features from the second database:
generating, by the second MLA, at least another portion of the plurality of query features.

5. The method of claim 2, further comprising:
generating, by the second MLA, an average annotation vector for the document, at least a portion of the average annotation vector being an average of at least a portion of the plurality of annotation vectors; and
storing, by the second MLA, the average annotation vector, the average annotation vector being associated with the document.

6. The method of claim 2, further comprising:
clustering, by the second MLA, the plurality of annotation vectors for the document into a predetermined number of clusters, the clustering being based on at least one of: the plurality of query features and the plurality of user interaction parameters;
generating, by the second MLA, an average annotation vector for each of the clusters; and
storing, by the second MLA, the average annotation vector for each of the clusters, the average annotation vector being associated with the document.

7. The method of claim 6, wherein the generating the plurality of annotation vectors comprises:
weighting at least one element of each annotation vector by a respective weighting factor, the respective weighting factor being indicative of a relative importance of the element for the clustering.

8. The method of claim 7, wherein the at least one user interaction parameter for each query comprises at least one of: a number of clicks, a click-through rate (CTR), a dwell time, a click depth, a bounce rate, and an average time spent on the document.

9. The method of claim 8, wherein the clustering is performed using one of: a k-means clustering algorithm, an expectation maximization clustering algorithm, a farthest first clustering algorithm, a hierarchical clustering algorithm, a cobweb clustering algorithm and a density clustering algorithm.

10. The method of claim 9, wherein each cluster of the predetermined number of clusters is at least partially indicative of a different semantic meaning.

11. The method of claim 9, wherein each cluster of the predetermined number of clusters is at least partially indicative of a similarity in user behavior.

12. A system for generating a plurality of annotation vectors for a document, the plurality of annotation vectors to be used as features by a first machine-learning algorithm (MLA) for information retrieval, the system executable by a second MLA on the system, the system comprising:
a processor;
a non-transitory computer-readable medium comprising instructions, the processor;
upon executing the instructions, being configured to:
retrieve, from a search log database, the document, the document having been indexed by a search engine server;
retrieve, by the second MLA from the search log database, a plurality of queries having been used to discover the document on the search engine server, the plurality of queries having been submitted by a plurality of users;
retrieve, by the second MLA from the search log database, a plurality of user interaction parameters for each one of the plurality of queries, the plurality of user interaction parameters being associated with the plurality of users;
generate, by the second MLA, the plurality of annotation vectors, each annotation vector being associated with a respective query of the plurality of queries, each annotation vector of the plurality of annotation vectors including an indication of:
the respective query,
a plurality of query features, the plurality of query features being at least indicative of linguistic features of the respective query, and
the plurality of user interaction parameters, the plurality of user interaction parameters being indicative of user behavior with the document by at least a portion of the plurality of users after having submitted the respective query on the search engine server.

13. The system of claim 12, wherein the plurality of query features further comprises at least one of: semantic features of the query, grammatical features of the query, and lexical features of the query.

14. The system of claim 13, wherein the processor is further configured to, prior to generating the plurality of annotation vectors:
retrieve, by the second MLA, at least a portion of the plurality of query features from a second database.

15. The system of claim 13, wherein the processor is further configured to, after retrieving at least the portion of the plurality of query features from the second database:
generate, by the second MLA, at least another portion of the plurality of query features.

16. The system of claim 13, wherein the processor is further configured to:
generate, by the second MLA, an average annotation vector for the document, at least a portion of the average annotation vector being an average of at least a portion of the plurality of annotation vectors; and
store, by the second MLA, the average annotation vector, the average annotation vector being associated with the document.

17. The system of claim 13, wherein the processor is further configured to:
cluster, by the second MLA, the plurality of annotation vectors for the document into a predetermined number of clusters, the clustering being based on at least one of: the plurality of query features and the plurality of user interaction parameters;
generate, by the second MLA, an average annotation vector for each of the clusters; and
store, by the second MLA, the average annotation vector for each of the clusters, the average annotation vector being associated with the document.

18. The system of claim 17, wherein to generate the plurality of annotation vectors, the processor is configured to:
weight at least one element of each annotation vector by a respective weighting factor, the respective weighting factor being indicative of a relative importance of the element for the clustering.

19. The system of claim 18, wherein the at least one user interaction parameter for each query comprises at least one of: a number of clicks, a click-through rate (CTR), a dwell time, a click depth, a bounce rate, and an average time spent on the document.

20. The system of claim 19, wherein the clustering is performed using one of: a k-means clustering algorithm, an expectation maximization clustering algorithm, a farthest first clustering algorithm, a hierarchical clustering algorithm, a cobweb clustering algorithm and a density clustering algorithm.
